(19) United States
(12) Patent Application Publication
(10) Pub. No.: US 2025/0389741 A1
(43) Pub. Date: Dec. 25, 2025

(54) SYSTEM AND METHOD FOR CONTROLLING A MEASURING DEVICE

(71) Applicant: NETZSCH-Gerätebau GmbH, Selb (DE)

(72) Inventors: Martin Brunner, Konradsreuth (DE); Michael Schöneich, Selb (DE); Thomas Denner, Selb (DE); Michael Müller, Trabitz (DE); Thilo Hilpert, Selb (DE); Fabian Wohlfahrt, Rehau (DE); Thorsten Hachmann, Thierstein (DE)

(21) Appl. No.: 19/193,898

(22) Filed: Apr. 29, 2025

Related U.S. Application Data
(60) Provisional application No. 63/662,298, filed on Jun. 20, 2024.

(30) Foreign Application Priority Data
Jun. 20, 2024 (DE) 102024117510.9

(51) Int. Cl. G01N 35/00

(52) U.S. Cl. CPC G01N 35/00871; G01N 35/00732; G01N 2035/00752

(57) ABSTRACT

A system (10) includes measuring devices (2) in a lab setting and a mobile terminal (1) for controlling the measuring devices (2). The mobile terminal (1) is configured to establish a wireless connection with one of the measuring devices (2) to perform a unique identification of the measuring device (2) connected, to transmit data to the measuring device (2) for controlling and/or managing the measuring device (2) identified and/or to receive data from the measuring device (2) identified.

### PRIORITY CLAIM

This application claims the priority benefit of U.S. Provisional Patent Application Ser. No. 63/662,298, filed Jun. 20, 2024, and German Patent Application No. 102024117510.9, filed Jun. 20, 2024, the disclosure of each of which is incorporated herein by reference in its entirety.

### TECHNICAL FIELD

The present invention relates to a system and a method for controlling a measuring device.

### BACKGROUND

Electronic measuring devices in a lab setting and the like usually have a touch screen and/or knobs and buttons for controlling and/or programming the measuring device or for reading out measurement data and/or settings. However, due to the usually small size of such touch screens, the user-friendliness of such measuring devices can be impaired. In addition, the effort required to control, program or read out a large number of identical or similar measuring devices can be very high. Particularly in a lab setting with a large number of measuring devices, there is a need to operate the measuring devices as efficiently and user-friendly as possible.

### SUMMARY

To solve the above-described problem, the present invention provides a system a method for controlling a measuring device. Further aspects of the invention are the subject-matter of the dependent claims, the drawings and the following description of exemplary embodiments.

A system according to the invention comprises a plurality of measuring devices in a lab setting and at least one mobile terminal for controlling the measuring devices. According to the invention, “controlling the measuring devices” is also understood to mean programming the measuring devices or reading out measurement data or settings from the measuring devices. By providing a mobile terminal for controlling the measuring devices, the measuring devices themselves will not need their own control device with a display, such as a screen or touch screen. Furthermore, buttons and/or keys can be largely dispensed with. In this way, the complexity of the measuring devices can be reduced. Furthermore, costs can be saved when manufacturing the measuring devices.

The mobile terminal is configured to establish a wireless connection with one of the plurality of measuring devices. For this purpose, the mobile terminal and the measuring devices each have suitable interfaces. Alternatively, in preferred embodiments of the invention, between the mobile terminal and the measuring devices there can be established a wired communication connection. For this purpose, the mobile terminal and the measuring devices can also have suitable interfaces, e.g. USB interfaces.

Identification of the measuring device can preferably be enabled by acquiring suitable identification data through the same wireless connection as for controlling the measuring device. Alternatively, the measuring device can first be identified through a first path and then a suitable data connection can be established with the measuring device identified. The identification data acquired may accordingly comprise information for establishing the wireless connection.

According to the invention, the mobile terminal performs a unique identification of the measuring device connected or to be connected. In order to control a specific measuring device, in particular from among a plurality of identical or similar measuring devices, it must be ensured that a unique assignment to the desired measuring device is established. In order to uniquely identify a measuring device, identification data can be exchanged, which, for example, is compared with a table or similar. The table can, for example, also contain information on establishing the wireless connection. In particular, each measuring device may have a unique identification number or code or the like, which may be, for example, assigned by the manufacturer or the user. For easier recognition of the measuring devices, names can, for example, also be assigned by the user.

The mobile terminal is configured to transmit data to the measuring device for controlling the measuring device identified and/or to receive data from the measuring device identified. The data received may, for example, be measurement data that can subsequently be stored, evaluated or further processed in some other manner.

According to preferred embodiments, one measuring device of the plurality of measuring devices may be an electronic device used in particular in a lab setting, such as a thermal analysis device and/or a thermal conductivity tester and/or a rheometer and/or a fire tester.

A preferred system comprises a server communicatively connected through an intranet or internet to the plurality of measuring devices and/or to the mobile terminal. The server may comprise a storage medium for storing the data and/or a cloud storage may be communicatively connected to the server and/or the system. The server may, for example, store a table with identification information. Understandable names for measuring devices can also be stored in the table. Furthermore, the server can store measurement data of the measuring devices and/or data for controlling and/or programming the measuring devices. This data can also be accessed through other end devices, such as, for example, a desktop computer or laptop, e.g. to evaluate measuring data from a plurality of measuring devices. The server can be connected through an intranet to increase the security of the data.

Preferably, the server stores identification information and the mobile terminal may be configured to retrieve the identification information from the server depending on data transmitted by the measuring device to the mobile terminal.

The measuring devices are preferably configured to output an acoustic and/or optical signal to a user after successful identification by the mobile terminal, in order to provide the user with confirmation of successful identification. To output an acoustic signal, the measuring device may have a suitable loudspeaker. To output an optical signal, the measuring device may have a suitable display and/or LED or the like. By providing an acoustic and/or visual output on the measuring device to be identified, the user can uniquely verify that the correct measuring device has been identified. This can improve the reliability of the system.

Alternatively, or additionally, the mobile terminal can also output an acoustic and/or visual indication to confirm successful identification to the user.

The mobile terminal can be configured to establish a wireless connection with the measuring device by means of RFID, Bluetooth, NFC or WLAN. For this purpose, the mobile terminal is preferably brought to a distance of less than 10 cm from the measuring device. Subsequently, the wireless connection between the mobile terminal and the desired measuring device can preferably be established automatically, i.e. without further input from the user. The successful establishment of the wireless connection can preferably be confirmed to the user on the mobile terminal and/or on the measuring device by means of a visual and/or acoustic output.

The mobile terminal can preferably have a reading device to acquire a QR code or an RFID tag or another suitable feature for unique identification of the measuring device. For reading a QR code attached to the measuring device, the mobile terminal can, for example, have a camera. For reading an RFID tag, the mobile terminal can have a suitable NFC interface.

The mobile terminal can be, for example, a laptop, a smartphone, a smartwatch or a tablet computer. The mobile terminal preferably comprises a touch screen, a processor, a communication interface and a memory.

Preferably, performing the unique identification of the measuring device comprises a step of performing near-field communication between the measuring device and the mobile terminal during the approach of the mobile terminal to the measuring device and a step of outputting a visual and/or acoustic signal by the measuring device when the measuring device has been successfully identified. Thus, the user can advantageously recognize when the identification of the measuring device has been successful.

### BRIEF DESCRIPTION OF THE DRAWINGS

The invention will be explained in greater detail with reference to exemplary embodiments depicted in the drawings as appended.

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 schematically illustrates a system comprising a plurality of measuring devices, a mobile terminal and a server in a lab setting; and

FIG. 2 illustrates a method according to the invention.

In the figures, like reference numerals denote like or functionally like components, unless indicated otherwise. Any directional terminology like “top”, “bottom”, “left”, “right”, “above”, “below”, “horizontal”, “vertical”, “back”, “front”, and similar terms are merely used for explanatory purposes and are not intended to delimit the embodiments to the specific arrangements as shown in the drawings.

### DETAILED DESCRIPTION OF THE INVENTION

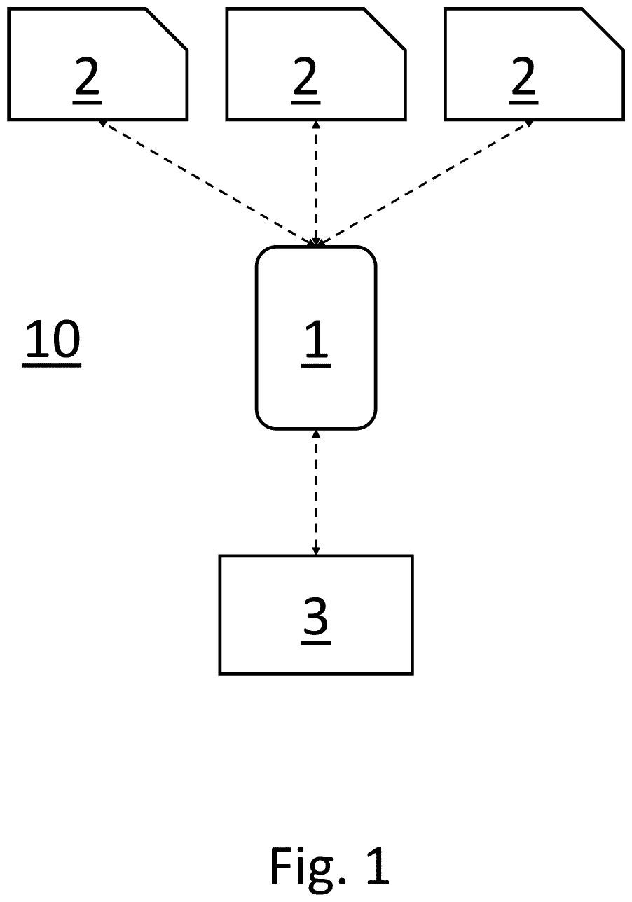

FIG. 1 schematically illustrates a system 10 comprising a plurality of measuring devices 2, a mobile terminal 1 and a server 3 in a lab setting. The mobile terminal 1 here is, for example, a particularly easy-to-use tablet 1 with a touch screen. The tablet 1 comprises an interface for wireless communication, e.g. via Bluetooth or WLAN. Further, the tablet comprises a camera and an interface for near-field communication (NFC), as well as a processor and a memory. The measuring devices 2 each comprise corresponding interfaces for communicating with the tablet 1.

The identifying of a measuring device 2 is carried out by acquiring suitable identification data, in particular through the same wireless connection as for controlling the measuring device 2. Alternatively, the measuring device 2 can first be identified through a first path and then a suitable data connection can be established from the tablet 1 to the measuring device 2 identified. The identification data acquired in this regard can comprise corresponding information for establishing the wireless connection.

The tablet 1 can perform a unique identification of the measuring device 2 connected or to be connected. In order to control a specific measuring device 2 from among the large number of identical or similar measuring devices 2, it must be ensured that a unique assignment to the desired measuring device 2 is established. In order to uniquely identify the measuring device 2, identification data is exchanged, which is, for example, compared with a table or similar. The table can, for example, also contain information on establishing the wireless connection. In particular, each measuring device 2 may have a unique identification number or code or the like, which may be, for example, assigned by the manufacturer or the user. For easier recognition of the measuring devices 2, names can, for example, also be assigned by the user.

The tablet 1 can transmit data for controlling the measuring device 2 identified to the measuring device 2 and/or receive data from the measuring device 2 identified. The data received may, for example, be measurement data that can subsequently be stored, evaluated or further processed in some other manner. The measurement data can also be transmitted to a server 3 and retrieved from there. Alternatively, the measurement data can also be transmitted to a storage medium or to cloud storage and retrieved therefrom.

The measuring devices 2 are electronic devices that are used in a lab setting. For example, the plurality of measuring devices 2 comprises a thermal analysis device and/or a thermal conductivity tester and/or a rheometer and/or a fire tester.

The system 10 comprises a server 3 that is communicatively connected or connectable to the plurality of measuring devices 2 and/or to the tablet 1 through an intranet or internet or another suitable network. The server 3 may, for example, store a table with identification information. In the table there can also be stored names for measuring devices 2 specified by the user. Furthermore, the server 3 can store measurement data of the measuring devices 2 and/or data for controlling and/or programming the measuring devices 2. This data can also be accessed through other end devices 1, such as, for example, a desktop computer or laptop, e.g. to evaluate measuring data from a plurality of measuring devices 2.

After a successful identification by the tablet 1, the measuring devices 2 can output an acoustic and/or optical signal to a user in order to provide the user with confirmation of the successful identification. To output the acoustic signal, the measuring devices 2 can each have a loudspeaker. To output the optical signal, the measuring devices 2 may comprise a display and/or LED or the like. By providing an acoustic and/or visual output on the measuring device 2 to be identified, the user can uniquely verify that the correct measuring device 2 has been identified. This can improve the reliability of the system 10.

Furthermore, the tablet 1 may also output an acoustic and/or visual advice to confirm successful identification to the user.

The tablet 1 can establish the wireless connection with the measuring device 2, in particular by means of RFID, Bluetooth, NFC or WLAN. For this purpose, the tablet 1 is approached to a distance of, for example, less than 10 cm from the measuring device 2. As a result, the wireless connection between the tablet 1 and the desired measuring device 2 can be established automatically, i.e. without further input from the user. The successful establishment of the wireless connection is confirmed to the user on the tablet 1 and/or on the measuring device 2 by means of a visual and/or acoustic output.

Further, the tablet 1 comprises a reading device to acquire, for example, a QR code or an RFID tag or another suitable feature for unique identification of the measuring device 2. For reading a QR code attached to the measuring device 2, the tablet 1 can have, for example, a camera. For reading an RFID tag, the tablet 1 can have a suitable NFC interface.

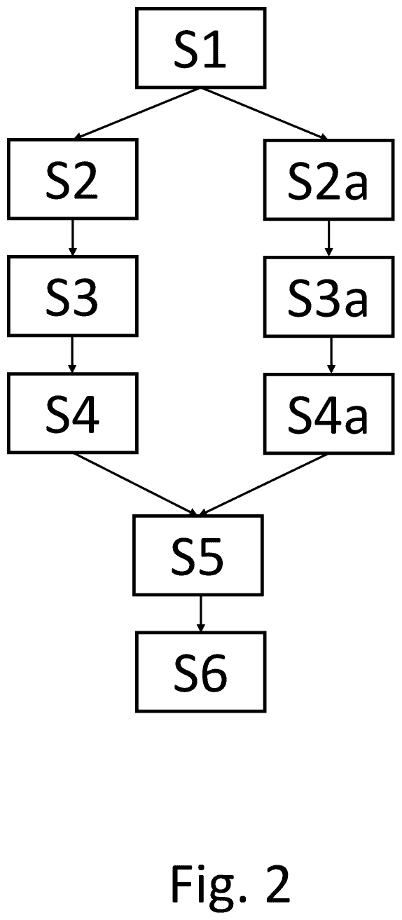

FIG. 2 illustrates a method according to the invention for controlling a measuring device. In the first step S1, the tablet 1 is approached to the measuring device 2. The second step S2 is used to acquire identification data of the measuring device 2 by the tablet 1. In the third step S3, a unique identification of the measuring device 2 is performed using the identification data. Subsequently, in step S4, a wireless connection is established with the measuring device 2 identified.

As an alternative to steps S2 to S4, in a step S2a, first there can be established a wireless connection with the measuring device 2. Then, in step S3a, identification data of the measuring device 2 is transmitted to the tablet 1 through the wireless connection. In step S4a, the unique identification of the measuring device 2 is performed using the identification data.

In step S5, data for controlling the measuring device 2 is transmitted from the tablet 1 to the measuring device 2 identified through the wireless connection. In an optional step S6, measurement data can be transmitted from the measuring device 2 to the tablet 1 through the wireless connection.

The step S3 or S4a for performing the unique identification of the measuring device 2 may include a step of performing a near-field communication between the measuring device 2 and the tablet 1 during the approaching S1 of the tablet 1 to the measuring device 2. Further, when the measuring device 2 is successfully identified, the optical and/or acoustic signal can be output by the measuring device 2 (and/or by the tablet 1).

What is claimed is:

1. A system (10), comprising:
a plurality of measuring devices (2) in a lab setting; and
a mobile terminal (1) for controlling the measuring devices (2), wherein the mobile terminal (1) is configured:
to establish a wireless connection with one of the plurality of measuring devices (2), to receive identification data from the measuring device (2) through the wireless connection, and to perform a unique identification of the connected measuring device (2) using the identification data; or
to acquire identification data of a desired measuring device (2), to perform a unique identification of a desired measuring device (2) using the identification data, and to establish a wireless connection with the measuring device (2) identified; and
to transmit data for controlling the measuring device identified (2) to the measuring device (2) through the wireless connection; and
to receive data from the measuring device (2) identified through the wireless connection.

2. The system (10) according to claim 1, wherein the plurality of measuring devices (2) comprises a thermal analysis device or a thermal conductivity tester or a rheometer or a fire tester or a combination of such measuring devices.

3. The system (10) according to claim 1, further comprising:
a server (3), a storage medium or a cloud storage, which is communicatively connected through an intranet or Internet with the plurality of measuring devices (2) and with the mobile terminal (1).

4. The system (10) according to claim 3, wherein the server (3) stores identification data and the mobile terminal (1) is configured to retrieve the identification data from the server (3) depending on data that the measuring device (2) transmits to the mobile terminal (1).

5. The system (10) according to claim 1, wherein the plurality of measuring devices (2) is configured to output an acoustic and/or optical signal to a user after successful identification by the mobile terminal (1).

6. The system (10) according to claim 1, wherein the mobile terminal (1) is configured to establish the wireless connection with the measuring device (1) by means of RFID, Bluetooth, NFC or WLAN.

7. The system (10) according to claim 1, wherein the mobile terminal (1) has a reading device to acquire a QR code or an RFID tag for unique identification of the measuring device (2).

8. The system (10) according to claim 1, wherein the mobile terminal device (1) is a laptop, a smartphone, a smartwatch or a tablet computer.

9. A method for controlling a measuring device (2), comprising:
approaching (S1) a mobile terminal (1) to the measuring device (2);
acquiring (S2) the identification data of the measuring device (2) by the mobile terminal (1) and performing (S3) unique identification of the measuring device (2) using the identification data and establishing (S4) a wireless connection with the measuring device (2) identified;
transmitting (S5) data for controlling the measuring device (2) from the mobile terminal (1) to the measuring device identified (2) through the wireless connection; and/or
transmitting (S6) measurement data from the measuring device (2) through the wireless connection to the mobile terminal (1).

10. The method according to claim 9, wherein performing (S3; S4a) the unique identification of the measuring device (2) comprises:
performing near-field communication between the measuring device (2) and the mobile terminal (1) during the approach of the mobile terminal (1) to the measuring device (2); and
outputting a visual and/or acoustic signal by the measuring device (2) when the measuring device (2) has been successfully identified.

11. A method for controlling a measuring device (2), comprising:
approaching (S1) a mobile terminal (1) to the measuring device (2);
establishing (S2a) a wireless connection with the measuring device (2) and transmitting (S3a) identification data of the measuring device (2) to the mobile terminal (1) through the wireless connection and performing (S4a) a unique identification of the measuring device (2) using the identification data;
transmitting (S5) data for controlling the measuring device (2) from the mobile terminal (1) to the measuring device identified (2) through the wireless connection; and/or
transmitting (S6) measurement data from the measuring device (2) through the wireless connection to the mobile terminal (1).

12. The method according to claim 11 wherein performing (S3; S4a) the unique identification of the measuring device (2) comprises:
performing near-field communication between the measuring device (2) and the mobile terminal (1) during the approach of the mobile terminal (1) to the measuring device (2); and
outputting a visual and/or acoustic signal by the measuring device (2) when the measuring device (2) has been successfully identified.
